(19) United States
(12) Patent Application Publication
(10) Pub. No.: US 2013/0110970 A1
(43) Pub. Date: May 2, 2013

(54) SYSTEMS AND METHODS TO PROVIDE DEMAND RESPONSE EVENTS

(71) Applicants: Mark Joseph Meyerhofer, Acworth, GA (US); Chad Eric Nodle, Marietta, GA (US); James Joseph Schmid, Acworth, GA (US); Jerry Steven Massey, Lawrenceville, GA (US); Bobby Antione Wilson, Lithia Springs, GA (US); Jaime Alberto Sierra, Atlanta, GA (US); Sthitaprajna Acharya, Alpharetta, GA (US); Osahun Lopepe Igunbor, Covington, GA (US)

(72) Inventors: Mark Joseph Meyerhofer, Acworth, GA (US); Chad Eric Nodle, Marietta, GA (US); James Joseph Schmid, Acworth, GA (US); Jerry Steven Massey, Lawrenceville, GA (US); Bobby Antione Wilson, Lithia Springs, GA (US); Jaime Alberto Sierra, Atlanta, GA (US); Sthitaprajna Acharya, Alpharetta, GA (US); Osahun Lopepe Igunbor, Covington, GA (US)

(21) Appl. No.: 13/283,443

(22) Filed: Oct. 27, 2011

(51) Int. Cl. G06F 15/16

(52) U.S. Cl. 709/217

(57) ABSTRACT

A computing device for use with a demand response system is provided. The computing device includes an interface that is configured to receive customer data of a plurality of customers. A processor is coupled to the interface and programmed to select a plurality of participants from the plurality of customers to participate in at least one demand response event based on the customer data received. The processor is further programmed to incrementally transmit a plurality of signals representative of the demand response event to the plurality of participants selected.

### BACKGROUND OF THE INVENTION

The field of the invention relates generally to demand response systems and, more particularly, to a computing device for use with a demand response system that enables utilities to selectively provide signals related to demand response events to its customers.

The combination of the increasing world population and the increased use of electric vehicles has created an increased electricity energy demand. Energy demand has also increased for use to power buildings, homes, and/or to charge batteries or other energy sources used in electric vehicles. The demand on the power grid has increased as the cost of fuel has increased. Such demands will likely cause an increase in the price of energy from the power grid. In particular, initially at least, the price of energy is likely to increase during peak times of high demand.

Currently, at least some known utilities use demand response systems that enable customers to enroll in at least one demand response program to manage the consumption of energy by their customers in response to supply conditions. Examples of demand response programs include a direct control program, a peak pricing program, such as, but limited to a critical peak pricing program, and a time of use program. The initiation and/or implementation of a demand response program by a utility is known as a demand response event. A demand response event is initiated by a utility transmitting a plurality of signals to its customers. For example, but not limited to, a demand response event representative of a direct load control program, is initiated when the utility transmits a signal to a device within a building, such as, but not limited to an in-home smart device and/or smart thermostat, such that the utility is enabled to directly control the usage of energy consuming machines within the building. A demand response event representative of a peak pricing program occurs when the utility transmits pricing signals to its customers during peak demand times. The pricing signals enable the utility to apprise customers of heightened energy prices during peak demand time periods such that customers may limit their energy consumption during such peak demand time periods. A demand response event representative of a time of use program occurs when the utility transmits a signal to a customer that is representative of energy prices that correspond to a time range such that the customer may identify an optimal time of day and/or day of the week to consume energy to ensure a low energy price rate.

Such demand response systems enable the utility to manage peak load conditions and to reduce energy demand among their customers. However, current demand response systems are unable to target specific customers and/or locations on their grid to reduce the chances of a failure of the grid. Moreover, current demand response systems are unable to prevent an overuse of a certain demand response event by its customers. Current demand response systems also transmit signals to all the customers and the signals are transmitted at the same time to all the customers, resulting in various problems, such as, but not limited to an increase in load leveling.

### BRIEF DESCRIPTION OF THE INVENTION

In one embodiment, a computing device for use with a demand response system is provided. The computing device includes an interface that is configured to receive customer data of a plurality of customers. A processor is coupled to the interface and programmed to select a plurality of participants from the plurality of customers to participate in at least one demand response event based on the customer data received. The processor is further programmed to incrementally transmit a plurality of signals representative of the demand response event to the plurality of participants selected.

In another embodiment, a demand response system is provided. The demand response system includes a computing device and at least one user notification device coupled to the computing device. The computing device includes an interface that is configured to receive customer data of a plurality of customers. A processor is coupled to the interface and programmed to select a plurality of participants from the plurality of customers to participate in at least one demand response event based on the customer data received. The processor is further programmed to incrementally transmit a plurality of signals representative of the demand response event to the plurality of participants selected. The user notification device is configured to receive at least one of the signals.

In yet another embodiment, a method for providing demand response events is provided. Customer data of a plurality of customers is received. A plurality of participants from the plurality customers are selected to participate in at least one demand response event based on the customer data that is received. A plurality of signals representative of the at least one demand response event are incrementally transmitted to the plurality of participants selected.

### BRIEF DESCRIPTION OF THE DRAWINGS

FIG. 1 is a block diagram of an exemplary demand response system;

FIG. 2 is a block diagram of an exemplary computing device that may be used with the demand response system shown in FIG. 1; and

FIG. 3 is a flow chart of an exemplary method that may be used for providing demand response events using the computing device shown in FIG. 2.

### DETAILED DESCRIPTION OF THE INVENTION

The exemplary systems and methods described herein overcome at least some known disadvantages of known demand response systems by enabling a utility to selectively transmit signals representative of demand response programs to customers. More specifically, the embodiments described herein provide a computing device for use with a demand response system. The computing device includes an interface that is configured to receive customer data of a plurality of customers, such as, but not limited to customers of a utility. A processor is coupled to the interface and programmed to select a plurality of participants from the plurality of customers to participate in at least one demand response event based on the customer data received. The processor is further programmed to incrementally transmit a plurality of signals representative of the demand response event to the plurality of participants selected. The user notification device is configured to receive at least one of the signals. By selecting valid participants and by transmitting staggered signals to the valid participants, as opposed to all the customers, the utility is able to target specific customers and/or locations on their grid to reduce the chances for a failure of the grid and there may be a reduction in load leveling. Moreover, by selectively transmitting signals to only valid participants, an overuse of a certain demand response event is prevented and the burden on every customer may be substantially reduced.

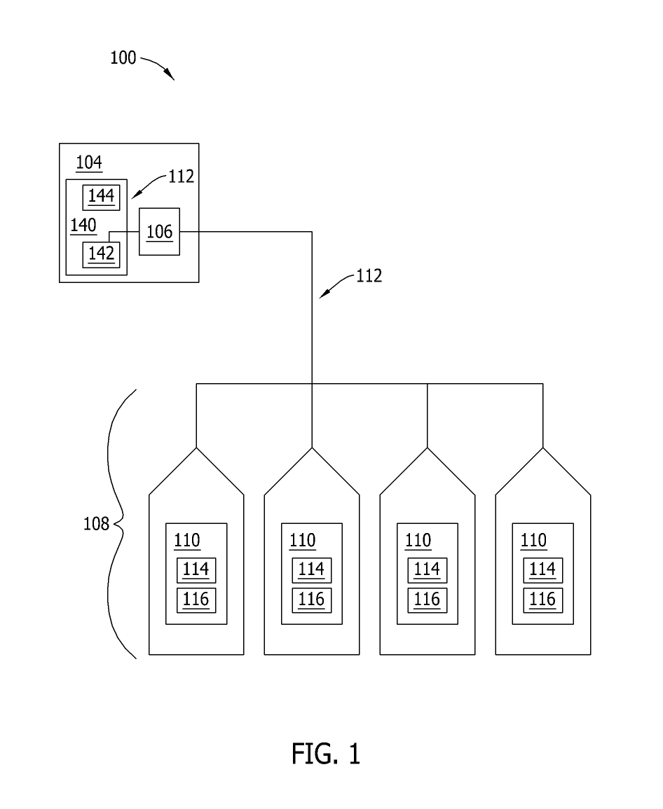

FIG. 1 illustrates a demand response system 100. In the exemplary embodiment, demand response system 100 includes a utility 104 and a computing device 106 positioned within utility 104, wherein computing device 106 enables utility 104 to communicate with customers. Alternatively, computing device 106 may not be positioned within utility 104 and may be positioned external to utility 104. Moreover, in the exemplary embodiment, computing device 106 is communicatively coupled to a plurality of buildings 108, wherein a plurality of customers may reside. It should be noted that, as used herein, the term “couple” is not limited to a direct mechanical, electrical, and/or communication connection between components, but may also include an indirect mechanical, electrical, and/or communication connection between multiple components.

More specifically, in the exemplary embodiment, computing device 106 is communicatively coupled to at least one user notification 110 device within each building 108 via a network 112 such that computing device 106 may communicate with user notification device 110. In the exemplary embodiment, user notification device 110 may be a computer, a cellular phone, and/or a smart device, including a smart box and/or smart thermostat. Alternatively, user notification device 110 may be any other device that is configured to communicate with computing device 106. Moreover, in the exemplary embodiment, user notification device 110 includes a user interface 114 that receives at least one input from a user, such as, but not limited to a customer of utility 104. In the exemplary embodiment, user interface 114 may include, for example, but not limited to a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Moreover, in the exemplary embodiment, user notification device 110 includes a presentation interface 116 that presents information, such as, but not limited to information regarding demand response programs and/or demand response events that are received from utility 104, input events and/or validation results, to the user. In the exemplary embodiment, presentation interface 116 includes a display adapter (not shown) that is coupled to at least one display device (not shown). More specifically, in the exemplary embodiment, the display device is a visual display device, such as, but not limited to a cathode ray tube (CRT), a liquid crystal display (LCD), an organic LED (OLED) display, and/or an “electronic ink” display. Alternatively, presentation interface 116 may include an audio output device (e.g., an audio adapter and/or a speaker) and/or a printer.

In the exemplary embodiment, computing device 106 may communicate with user notification device 110 using a wired network connection (e.g., Ethernet or an optical fiber), a wireless communication means, such as, but not limited to radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. WIMAX is a registered trademark of WiMax Forum, of Beaverton, Oreg. IEEE is a registered trademark of the Institute of Electrical and Electronics Engineers, Inc., of New York, N.Y. More specifically, in the exemplary embodiment, user notification device 110 is configured to receive at least one signal from computing device 106 that is representative of at least one demand response event. In the exemplary embodiment, the demand response event initiates the implementation of a demand response program that may include a direct load control program, a peak pricing program, such as, but not limited to a critical peak pricing program, and/or a time of use program.

In the exemplary embodiment, utility 104 also includes a data management system 140 that is coupled to computing device 106 via network 112. Alternatively, data management system 140 may be separate from utility 104. Data management system 140 may be any device capable of accessing network 112 including, without limitation, a desktop computer, a laptop computer, or other web-based connectable equipment. More specifically, in the exemplary embodiment, data management system 140 includes a database 142 that includes customer data for each of the customers of utility 104. In the exemplary embodiment, database 142 can be fully or partially implemented in a cloud computing environment such that data from the database is received from one or more computers (not shown) within utility 104 or remote from utility 104. In the exemplary embodiment, the customer data may include an enrollment period and/or an enrollment status for each customer for participating in at least one demand response program. For example, but not limited to, the data may include a selection made by each customer for at least one demand response program to participate in. The customer data may also include a participation history for each customer. The participation history may include, for example, but not limited to, the previous demand response events that each customer has participated in. The customer data may also include a geographic area of each customer, such as, but not limited to the geographic area where each customer resides.

Moreover, in the exemplary embodiment, data management system 140 includes a user interface 144 that receives at least one input from a user, such as, but not limited to an operator and/or employee of utility 104. In the exemplary embodiment, data management system user interface 144 may include, for example, but not limited to a keyboard, a pointing device, a mouse, a stylus, a touch sensitive panel (e.g., a touch pad or a touch screen), a gyroscope, an accelerometer, a position detector, and/or an audio input interface (e.g., including a microphone) that enables the user to input pertinent information.

Data management system 140 may communicate with computing device 106 using a wired network connection (e.g., Ethernet or an optical fiber), a wireless communication means, such as, but not limited to radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. More specifically, in the exemplary embodiment, data management system 140 transmits the customer data to computing device 106. While the customer data is shown as being stored in database 142 within data management system 140 in the exemplary embodiment, it should be noted that the customer data may be stored in another system and/or device. For example, but not limited to, computing device 106 may store the customer data therein.

During operation, utility 104 transmits, for example, but not limited to a questionnaire to its customers via computing device 106. The questionnaire provides questions to each customer to answer regarding the customer and the questionnaire provides various demand response programs that each customer may elect to participate in. More specifically, in the exemplary embodiment, the questionnaire is transmitted to user notification device 110. Each customer may input various responses to the questionnaire via user interface 114, including selecting at least one demand response program to participate in. Alternatively, customers may provide responses to utility 104 via other means and utility 104 may input the information in computing device 106. Moreover, utility 104 may input additional information regarding each customer to computing device 106.

In the exemplary embodiment, if a customer provides his or her responses via user notification device 110, then the information that the customer provides is transmitted to computing device 106 via network 112. Computing device 106 then transmits the information to data management system 140, wherein the data is stored in database 142. If a customer provides his or her responses via other means, utility 104 may receive the information and a user, such as, but not limited to an employee of utility 104, may input the data to data management system 140 via data management system user interface 144, wherein the data may be stored in database 142.

When utility 104 needs to initiate and/or implement a demand response program, the user may manually input the initiation and/or implementation of a demand response event to computing device 106 at a particular time. The user may also manually input the names of the customers such that computing device 106 may transmit at least one signal representative of at least one demand response event to the customers that are identified by the user.

Alternatively, computing device 106 may be programmed to select a plurality of participants of the plurality of customers of utility 104 for participating in at least one demand response event that is provided by utility 104. More specifically, in the exemplary embodiment, computing device 106 receives customer data from database 142 and selects the participants based on the customer data received. For example, but not limited to the participants selected may be the customers who have enrolled in a demand response program that corresponds to the demand response event that is to be scheduled and/or the customers who have a participation history of participating in similar demand response events. Computing device 106 then incrementally transmits a signal representative of the demand response event to each selected participant. For example, but not limited to, thirty percent of the selected participants may receive the signal first, and then another thirty percent of the selected participants may receive the signal fifteen minutes later until all the selected participants have received the signal. Moreover, in the exemplary embodiment, each selected participant receives the signal of the demand response event via user notification device 110. For example, but not limited to, if a selected participant elected to participate in a critical peak pricing program, a signal representative of a demand response event that corresponds to the critical peak pricing program will be transmitted to the participant at the appropriate time via user notification device 110.

By selecting valid participants and by transmitting staggered signals to the valid participants, as opposed to all the customers, utility 104 is able to target specific customers and/or locations on their grid (not shown) to reduce the chances for a failure of the grid and there may be a reduction in load leveling. Moreover, by selectively transmitting signals to only valid participants, an overuse of a certain demand response program is prevented and the burden on every customer may be substantially reduced.

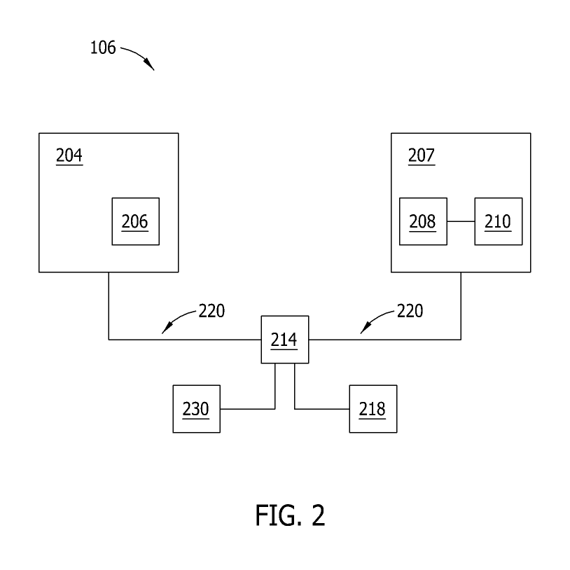

FIG. 2 is a block diagram of computing device 106. In the exemplary embodiment, computing device 106 includes a user interface 204 that receives at least one input from a user, such as, but not limited to an employee of utility 104 (shown in FIG. 1). In the exemplary embodiment, user interface 204 includes a keyboard 206 that enables the user to input pertinent information. Alternatively, user interface 204 may include, for example, but limited to a pointing device, a mouse, a stylus, a touch sensitive panel (e.g., a touch pad or a touch screen), a gyroscope, an accelerometer, a position detector, and/or an audio input interface (e.g., including a microphone).

Moreover, in the exemplary embodiment, computing device 106 includes a presentation interface 207 that presents information, such as, but not limited to input events and/or validation results, to the user. In the exemplary embodiment, presentation interface 207 includes a display adapter 208 that is coupled to at least one display device 210. More specifically, in the exemplary embodiment, display device 210 is a visual display device, such as, but not limited to a cathode ray tube (CRT), a liquid crystal display (LCD), an organic LED (OLED) display, and/or an “electronic ink” display. Alternatively, presentation interface 207 may include an audio output device (e.g., an audio adapter and/or a speaker) and/or a printer.

Computing device 106 also includes a processor 214 and a memory device 218. In the exemplary embodiment, processor 214 is coupled to user interface 204, presentation interface 207, and to memory device 218 via a system bus 220. In the exemplary embodiment, processor 214 communicates with the user, such as, but not limited to by prompting the user via presentation interface 207 and/or by receiving user inputs via user interface 204. Moreover, in the exemplary embodiment, processor 214 is programmed by encoding an operation using one or more executable instructions and providing the executable instructions in memory device 218. For example, but not limited to, processor 214 is programmed to select a plurality of participants for participating in at least one demand response event based on customer data that computing device 106 receives from the customers and/or utility 104. More specifically, in the exemplary embodiment, processor 214 is programmed to select the participants by considering an enrollment period and/or an enrollment status in at least one demand response program, such as, but not limited to a direct load control program, a peak pricing program, and/or a time of use program, for each customer. Processor 214 is also programmed to select the participants by considering a participation history of the customers for participating in demand response events in the past. Moreover, processor 214 is programmed to select participants by considering a geographic area, such as, but not limited to where each participant resides. Processor 214 is also programmed to select participants by considering the type of demand response program that each customer is enrolled in, such as, but not limited to whether the customer is enrolled in a direct load control program, a peak pricing program, and/or a time of use program.

In the exemplary embodiment, processor 214 is further programmed to incrementally transmit a plurality of signals representative of the demand response event to the selected participants. More specifically, in the exemplary embodiment, processor 214 organizes the selected participants in a hierarchy and processor 214 incrementally transmits the signal based on the hierarchy. In the exemplary embodiment, processor 214 is programmed to organize at least one participant who is most likely to participate in a demand response event in a first tier of the hierarchy and organize at least one participant who is least likely to participate in a demand response event in a last tier of the hierarchy.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as, but not limited to executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by a user via user interface 204, and/or information received from other components of demand response system 100 (shown in FIG. 1), such as, but not limited to from user notification device 110 (shown in FIG. 1).

Computing device 106, in the exemplary embodiment, also includes a communication interface 230 that is coupled to processor 214 via system bus 220. Moreover, in the exemplary embodiment, communication interface 230 is communicatively coupled to user notification device 110 via network 112 (shown in FIG. 1). In the exemplary embodiment, communication interface 230 communicates with user notification device 110, and/or other components within system 100.

During operation, when utility 104 needs to initiate and/or implement a demand response program, the user may manually input the initiation and/or implementation of a demand response event to computing device 106 at a particular time. The user may also manually input the names of the customers such that computing device 106 may transmit at least one signal representative of at least one demand response event to the customers that are identified by the user.

Alternatively, computing device 106 may be programmed to select a plurality of participants of the plurality of customers of utility 104 for participating in at least one demand response event that is provided by utility 104. In the exemplary embodiment, computing device 106 receives customer data from database 142 (shown in FIG. 1) and selects the participants based on the customer data received. More specifically, the customer data is transmitted to communication interface 230 and then processor 214 selects the participants. In the exemplary embodiment, processor 214 selects a plurality of participants for at least one demand response program by considering an enrollment period and/or an enrollment status in at least one demand response program. For example, but not limited to, the customer data may show that customers may have elected to participate in a demand response program and/or may have elected to participate in the demand response program for specific period of time (i.e., for only two months or for only one week). Customers may have also elected to not participate in any demand response program.

In the exemplary embodiment, processor 214 may also select the participants by considering a participation history for the customers in demand response events in the past. More specifically, the customer data may include historical information about each customer that processor 214 considers. Moreover, processor 214 may select participants by considering a geographic area, such as, but not limited to where each customer resides. Processor 214 may also select participants by considering the type of demand response program that each customer is enrolled in, such as, but not limited to whether the customer is enrolled in a direct load control program, a peak pricing program, and/or a time of use program.

When processor 214 has selected the participants for participating in at least one demand response, processor 214 then incrementally transmits a signal representative of a demand response program to each selected participant. More specifically, in the exemplary embodiment, processor 214 organizes the selected participants in a hierarchy and processor 214 incrementally transmits the signals based on the hierarchy. For example, but not limited to, processor 214 organizes at least one participant who is most likely to participate in a demand response event in a first tier of the hierarchy and organize at least one participant who is least likely to participate in a demand response event in a last tier of the hierarchy. As such, in the exemplary embodiment, selected participants who are more likely to participate in the demand response program may receive the signal before selected participants who are not likely to participate. For example, but not limited to, thirty percent of the selected participants may receive the signal first, and then another thirty percent of the selected participants may receive the signal fifteen minutes later until all the participants have received the signal.

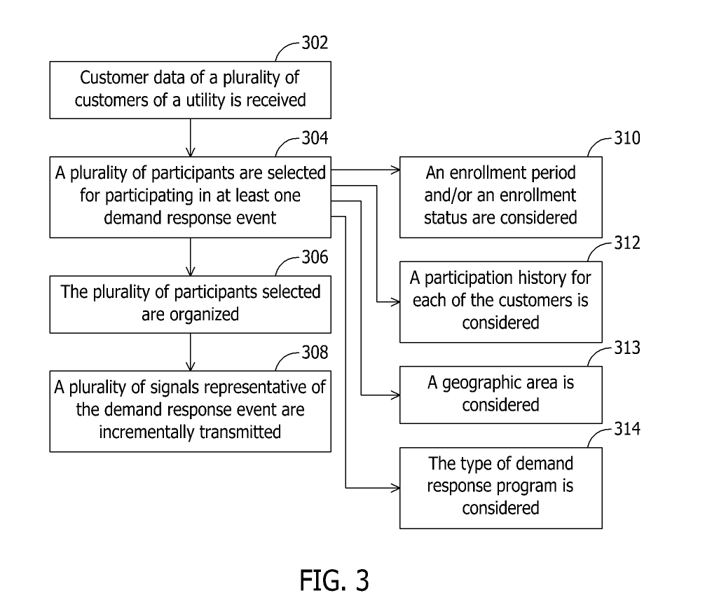

FIG. 3 is a flow chart of a method 300 that may be used for providing demand response events using a computing device, such as, but not limited to computing device 106 (shown in FIGS. 1 and 2). Customer data of a plurality of customer of a utility 104 (shown in FIG. 1) is received 302, via communication interface 230 (shown in FIG. 2). A plurality of participants of the customers are selected 304 for participating in at least one demand response event based on the customer data. The plurality of participants selected are organized 306 in a hierarchy. A plurality of signals representative of the demand response event are incrementally transmitted 308 to the selected participants.

In the exemplary embodiment, when the participants are selected 304, an enrollment period and/or an enrollment status in at least one demand response program for each customer are considered 310. Moreover, a participation history for each of the customers is considered 312. A geographic area for each customer is considered 313. The type of demand response program that each customer is enrolled in is also considered 314.

As compared to known demand response systems that are used to enable utilities to manage customers and/or energy consumption by the implementation of demand response programs, the exemplary apparatus, systems, and methods described herein enable a utility to selectively transmit signals representative of demand response events to its customers. More specifically, the embodiments described herein provide a computing device for use with a demand response system. The computing device includes an interface that is configured to receive customer data of a plurality of customers, such as, but not limited to customers of a utility. A processor is coupled to the interface and programmed to select a plurality of participants from the plurality of customers to participate in at least one demand response event based on the customer data received. The processor is further programmed to incrementally transmit a plurality of signals representative of the demand response event to the plurality of participants selected. The user notification device is configured to receive at least one of the signals. By selecting valid participants and by transmitting staggered signals to the valid participants, as opposed to all the customers, the utility is able to target specific customers and/or locations on their grid to reduce the chances for a failure of the grid and there may be a reduction in load leveling. Moreover, by selectively transmitting signals to only valid participants, an overuse of a certain demand response event is prevented and the burden on every customer may be substantially reduced.

A technical effect of the systems and methods described herein includes at least one of (a) receiving customer data of a plurality of customers; (b) selecting a plurality of participants from a plurality customers to participate in at least one demand response event based on customer data received; and (c) transmitting incrementally a plurality of signals representative of at least one demand response event to a selected plurality of participants.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, but not limited to, the system may also be used in combination with other apparatus, systems, and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for use with a demand response system, said computing device comprising:
an interface configured to receive customer data of a plurality of customers; and
a processor coupled to said interface and programmed to select a plurality of participants from the plurality of customers to participate in at least one demand response event based on the customer data received, said processor is further programmed to incrementally transmit a plurality of signals representative of the at least one demand response event to the plurality of participants selected.

2. A computing device in accordance with claim 1, wherein said processor selects the plurality of participants by considering at least one of an enrollment period and an enrollment status in at least one demand response program for each customer.

3. A computing device in accordance with claim 1, wherein said processor selects the plurality of participants by considering a participation history of each customer in the at least one demand response event.

4. A computing device in accordance with claim 1, wherein said processor selects the plurality of participants by considering a geographic area of each customer.

5. A computing device in accordance with claim 1, wherein said processor selects the plurality of participants by considering whether each customer is enrolled in at least one of a direct load control program, a peak pricing program, and a time of use program.

6. A computing device in accordance with claim 1, wherein said processor is further programmed to organize the plurality of participants selected in a hierarchy, said processor incrementally transmits the plurality of signals based on the hierarchy.

7. A computing device in accordance with claim 6, wherein said processor organizes at least one participant of the plurality of participants selected who is most likely to participate in the at least one demand response event in a first tier of the hierarchy, said processor further organizes at least one participant of the plurality of participants selected who is least likely to participate in the at least one demand response event in a last tier of the hierarchy.

8. A demand response system comprising:
a computing device comprising:
an interface configured to receive customer data of a plurality of customers; and
a processor coupled to said interface and programmed to select a plurality of participants from the plurality of customers to participate in at least one demand response event based on the customer data received, said processor is further programmed to incrementally transmit a plurality of signals representative of the at least one demand response event to the plurality of participants selected; and
at least one user notification device coupled to said computing device and configured to receive at least one of the plurality of signals.

9. A demand response system in accordance with claim 8, wherein said at least one user notification device is at least one of a phone, a computer system, and a smart device.

10. A demand response system in accordance with claim 8, wherein said processor selects the plurality of participants by considering at least one of an enrollment period and an enrollment status in at least one demand response event for each customer.

11. A demand response system in accordance with claim 8, wherein said processor selects the plurality of participants by considering a participation history of each customer in the at least one demand response event.

12. A demand response system in accordance with claim 8, wherein said processor selects the plurality of participants by considering a geographic area of each customer.

13. A demand response system in accordance with claim 8, wherein said processor selects the plurality of participants by considering whether each customer is enrolled in at least one of a direct load control program, a peak pricing program, and a time of use program.

14. A demand response system in accordance with claim 8, wherein said processor is further programmed to organize the plurality of participants selected in a hierarchy, said processor incrementally transmits the plurality of signals based on the hierarchy.

15. A demand response system in accordance with claim 14, wherein said processor organizes at least one participant of the plurality of participants selected who is most likely to participate in the at least one demand response event in a first tier of the hierarchy, said processor further organizes at least one participant of the plurality of participants selected who is least likely to participate in the at least one demand response event in a last tier of the hierarchy.

16. A method for providing demand response events, said method comprising:
receiving customer data of a plurality of customers;
selecting a plurality of participants from the plurality customers to participate in at least one demand response event based on the customer data received; and
transmitting incrementally a plurality of signals representative of the at least one demand response event to the plurality of participants selected.

17. A method in accordance with claim 16, wherein selecting a plurality of participants further comprises selecting a plurality of participants by considering at least one of an enrollment period and an enrollment status in at least one demand response program for each customer.

18. A method in accordance with claim 16, wherein selecting a plurality of participants further comprises selecting a plurality of participants by determining a participation history of each customer in the at least one demand response event.

19. A method in accordance with claim 16, wherein selecting a plurality of participants further comprises selecting a plurality of participants by considering a geographic area of each customer.

20. A method in accordance with claim 16, further comprising organizing the plurality of participants selected in a hierarchy, wherein transmitting incrementally a plurality of signals is based on the hierarchy.
